(19) United States
(12) Patent Application Publication
(10) Pub. No.: US 2025/0360482 A1
(43) Pub. Date: Nov. 27, 2025

(54) ROTATING LIQUID FILM REACTOR WITH GAS-LIQUID CONCURRENT AND USE THEREOF IN PREPARATION OF METAL HYDROXIDES

(71) Applicant: BEIJING UNIVERSITY OF CHEMICAL TECHNOLOGY, Beijing (CN)

(72) Inventors: Yanjun LIN, Beijing (CN); Yanan LIU, Beijing (CN); Kaitao LI, Beijing (CN); Yingying ZHANG, Beijing (CN)

(21) Appl. No.: 18/898,253

(22) Filed: Sep. 26, 2024

(30) Foreign Application Priority Data
May 22, 2024 (CN) 202410636723.4

(51) Int. Cl. B01J 19/18; C01B 13/20

(52) U.S. Cl. CPC B01J 19/1887; C01B 13/20

(57) ABSTRACT

The present disclosure relates to a rotating liquid film reactor with gas-liquid concurrent and use thereof in preparation of metal hydroxides. The present disclosure starts from the basic process of preparing metal hydroxides by a gas-liquid precipitation method, and designs a rotating liquid film reactor with gas-liquid multi-fluid concurrent through computational fluid dynamics simulation analysis. Multiple gas-liquid fluid inlets are constructed, and the traditional vertical inlet is improved to tangential feed along the rotation direction, which enhances the forced mixing process of gas and liquid phases in the reaction space, and intensifies the micro-mixing and nucleation process of reactant ions. An inlet anti overflow device is further provided to prevent fluid from overflowing upwardly upon increasing the inlet flow volume, thereby improving product quality control and achieving effective control of particle size and distribution in nucleation while improving production efficiency and quality, obtaining products with smaller particle size and narrower distribution. The particle size of the product is controlled within the range of 15-200 nm, while the primary particle size distribution range is reduced to 30-60 nm.

### TECHNICAL FIELD

The present disclosure belongs to the field of preparation equipment for inorganic functional materials, in particular to a rotating liquid film reactor with gas-liquid concurrent and use thereof in preparation of metal hydroxides.

### BACKGROUND

Metal hydroxides are alkaline and susceptible to decomposition by heating to produce metal oxides. Most of them are insoluble or slightly soluble in water, such as magnesium hydroxide, aluminum hydroxide, and rare earth hydroxide. Due to easy accessibility of raw materials, simple preparation, and excellent performance, metal hydroxides are widely used in various fields such as acid absorption, tail gas treatment, building materials, and military industry. For example, magnesium hydroxide, as an important inorganic salt compound, is widely used as flame retardant, neutralizing agent for acidic wastewater, precipitating agent for heavy metal wastewater, flue gas desulfurization agent, cosmetics, food additives, and the like. Meanwhile, it is also an important raw material for the production of magnesium oxide. Especially as an inorganic flame retardant, it is of increasing preferences in the past two decades due to its high decomposition temperature, strong smoke suppression ability, excellent flame retardant effect, and no production of toxic or corrosive substances after decomposition. The particle size distribution and morphology of hydroxides have a significant impact on their performance. Therefore, preparing hydroxides with small particle size and narrow particle size distribution is of great significance for their applications.

The precipitation method is one of the most commonly used methods for synthesizing hydroxides. It is characterized by a simple reaction process, facilitating large-scale industrial production. Common precipitation methods include liquid-liquid phase precipitation, gas-liquid phase precipitation, etc. In a traditional precipitation method for preparing hydroxides, since the nucleation process and the crystallization process are inseparable, the resulted product has uneven particle sizes and a wide particle size distribution, which greatly affects product performance and large-scale production. To cope with the above problem, the inventor team created a rotating liquid film reactor (CN20121010556.7) capable of quickly mixing fluids in a confined space in turbulent form such that the product obtained by precipitation reaction has a small particle size and a narrow particle size distribution. It has been widely applied in the preparation of layered double hydroxides and hydroxides through liquid-liquid reactions. However, due to the differences between gas-liquid phase fluid and liquid-liquid phase fluid in characteristic and collision reaction mechanisms, the above-mentioned reactor is adapted only for liquid-liquid phase precipitation reaction rather than gas-liquid phase precipitation. The gas-liquid phase reaction is an important pathway to prepare inorganic materials such as hydroxides, which has been widely used in the preparation of various materials such as magnesium hydroxide, aluminum hydroxide, rare earth hydroxide, etc. Therefore, the development of gas-liquid phase rotating liquid film reactors is of great significance for improving the particle size, morphology control, and large-scale production of magnesium hydroxide and other hydroxides.

### SUMMARY

In order to enhance the gas-liquid fluid mixing process in the reactor, intensify the micro mixing of reactants, improve the nucleation process, achieve effective control of particle size and particle size distribution of the products while improving production efficiency and product quality, the present disclosure provides a rotating liquid film reactor with gas-liquid concurrent and use thereof in preparation of metal hydroxides.

The rotating liquid film reactor with gas-liquid multi-fluid concurrent comprises a closed casing as a stator, the stator has an upper end that is closed; a rotatable conical rotor is provided in the stator, a motor is connected with the rotor from below; a reactor body is composed of the stator and the rotor that is rotatable freely and connected to the motor; a plurality of liquid feed ports are symmetrically arranged on both left and right sides of the stator, a liquid is fed in a direction tangential to a direction of rotation of the rotor, the liquid feed ports are located between the stator and the rotor, and a lower end of the liquid feed ports is lower than an upper edge of the rotor and located in an upper half portion of the rotor; a gas feed port is constructed at a central position of the stator, gas is introduced into the upper half portion of the rotor; a gas disperser is provided in the rotor; a reaction liquid is injected through the liquid feed port, either from the same side or opposite sides, to a level of ¼ to ½ of a height of the inlet in the rotor; a gas is injected through the gas feed port and uniformly outflows through the gas disperser, a height of a gas outlet is lower than that of a liquid outlet; a discharge port is provided at a lower end of the stator.

The feed port is provided in four arranged in a cross pattern, in six uniformly distributed at an angle of 60°, or in eight uniformly distributed at an angle of 45°.

An anti overflow device is further provided by providing two circular hole-type adjusting bolts on opposite sides horizontally above the stator at a height of 10-20 cm, which are connected with the rotor inside.

An inner wall of the stator and a surface of the rotor are engraved with threads in a direction at 10° to 170°.

The stator is secured by a protective cover at an exterior thereof.

A stator-rotor clearance is 0.1-0.5 mm, and a rotor height is 5-25 cm.

The inclination angle of the rotor which is an angle between an inclined edge and a bottom edge of the rotor in the vertical direction is in the range of 36° to 86°. The angle being in the range of 60° to 75° contributes to an increase of the turbulent mixing effect, which improves the produce yield and the nucleation efficiency.

A bore diameter of the disperser is 1-3 mm.

A rotor speed is in a range of 50 to 8000 rpm, and a fluid mixing flow rate in the reactor is 7 to 150 m/s.

The rotating liquid film reactor with gas-liquid multi-fluid concurrent has a use in the preparation of metal hydroxides.

The metal hydroxides are magnesium hydroxide, aluminum hydroxide, or lanthanum hydroxide. An ammonia gas is introduced through the gas feed port, and a magnesium salt solution, an aluminum salt solution, or a lanthanide salt solution is introduced through the liquid feed port.

The internal flow field in fluids mixed in the rotating liquid film reactor with gas-liquid multi-fluid concurrent is simulated through fluid dynamics calculations. At a low speed, a turbulence model is used to increase the mass flow at the inlet and enhance the fluid mixing effect, thereby improving the nucleation efficiency of the co-precipitation reaction, and in turn controlling the crystallite dimension of the product. By increasing the rotor speed, the fluid mixing speed in the reactor increases, so the fluids are mixed uniformly, which increases the product yield in the reactor.

Advantageous effects of the present disclosure: Starting from the basic process of preparing metal hydroxides by a precipitation method, the present disclosure simulates the fluid mixing process in a rotating liquid film reactor with gas-liquid multi-fluid concurrent based on computational fluid dynamics (CFD). The reactor is set at a speed in the range of 50 to 8000 rpm, and a turbulence model is selected. Based on the reaction of synthesizing metal hydroxides by a precipitation method, the mass fraction of the production of metal hydroxides in the reactor is analyzed based on a RNG k-ε model. The results show that the rotating liquid film reactor with a gas-liquid multi-fluid inlet effectively improves the product yield and increases flow velocity in the reactor, and enhances the mixing effect of gas-liquid phase fluids in the reactor. When the rotor speed of the reactor increases, the fluid mixing speed inside the reactor increases, the mass transfer effect of fluid mixing is enhanced. The rotor inclination angle within the range of 60° to 75° results in the highest product yield, the best fluid mixing effect, and a stable and uniform fluid mixing speed in the reactor. Two circular hole-type adjusting bolts are provided on a horizontal plane above the stator, with a height of 10-20 cm, which are connected with the anti-overflow device of the rotor inside, which prevents fluid overflow when the flow rate is increased, improves the yield, increases the mixing efficiency of the fluids in the reactor, and improves the control of product quality. The present disclosure designs a rotating liquid film reactor with gas-liquid multi-fluid concurrent, allowing fluids to quickly flow into the reactor through multiple inlets. By increasing the volumetric flow rate of fluids that participate in reaction per unit time and increasing the effect and efficiency of fluid mixing during the motion of the rotor, the precipitation reaction is more complete and products with smaller particle sizes and narrower size distribution are obtained. The fluid flows into the stator-rotor clearance at approximately ¼ to ¾ a height thereof, avoiding the phenomenon of reactant overflow when the mass flow rate at the inlet increases. By adjusting the rotor angle, the product yield from fluid mixing is significantly improved. The fluid flows in turbulent form in the rotor-stator clearance, which improves the forced mixing process of the two-phase fluid in the reaction space, intensifies the micro-mixing and nucleation process of reactant ions, achieving efficient control of particle size and particle size distribution in the nucleation while improving production efficiency and product quality. Products of smaller particle size and narrower particle size distribution are obtained. The practical size of the product is controlled within the range of 15-200 nm, while the primary particle size distribution range is reduced to 30-60 nm. The maximum yield of magnesium hydroxide is increased from 30% to over 95%.

### BRIEF DESCRIPTION OF THE DRAWINGS

FIG. 1 is a schematic diagram of the front structure of a rotating liquid film reactor with gas-liquid multi-fluid concurrent of the present disclosure. Reference numerals: 1—gas feed port, 2—liquid feed port, 3—anti overflow device, 4—stator casing, 5—rotor, 6—outlet, 7—motor, 8—adjusting bolt in slot, 9—stator, 10—base.

FIG. 2 shows the top views of 4, 6, and 8 liquid feed ports, respectively.

FIG. 3 is the XRD pattern of the layered magnesium hydroxide in Example 1.

FIG. 4 is an SEM image of the layered aluminum hydroxide in Example 1.

FIG. 5 shows the laser particle size distribution of lanthanum hydroxide obtained from Example 2.

### DETAILED DESCRIPTION

### Example 1

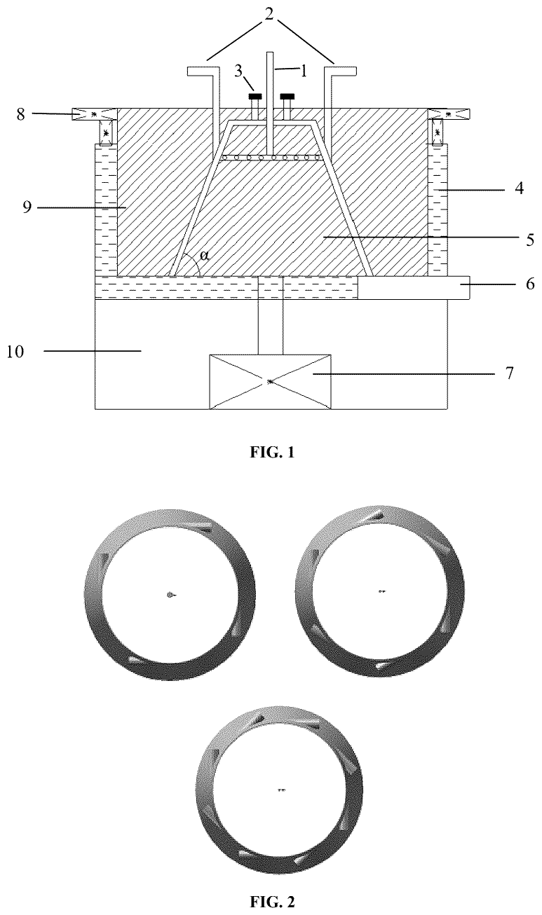

A rotating liquid film reactor with gas-liquid multi-fluid concurrent in FIG. 1 comprises a closed casing as a stator, the stator has an upper end that is closed; a rotatable conical rotor is provided in the stator, a motor is connected with the rotor from below; a reactor body is composed of the stator and the rotor that is rotatable freely and connected to the motor. The stator-rotor clearance is 0.1-0.5 mm. The inner wall of the stator and the surface of the rotor are engraved with threads in a direction at 80°. The rotor height is 8 cm, and the inclination angle of the rotor is 72°. An anti overflow device is further provided by providing a circular hole-type adjusting bolt on a horizontal plane above the stator, with a height of 10 cm, configured to be connected with the rotor inside. Four liquid feed ports arranged in a cross pattern are provided symmetrically on both left and right sides of the stator. The liquid feed ports are located between the stator and the rotor, and the lower end of the liquid feed ports is lower than the upper edge of the rotor. The reaction liquid is injected in a direction tangential to a direction of rotation of the rotor. The gas feed ports are located in the upper middle part of the rotor, and the gas flows out through a gas disperser with a bore diameter of 1 mm. The inclination angle of the rotor is an angle between an inclined edge and a bottom edge of the rotor in the vertical direction.

Specific operations in the use of the rotating liquid film reactor with gas-liquid multi-fluid concurrent in the preparation of magnesium hydroxide are described below.

MgCl₂ and NH₃ were injected at a molar ratio NH₃/Mg²⁺=2.5:1 in the same feed time, where [Mg²⁺]=1.0 mol/L, and the liquids were injected through four liquid feed ports at 0.1 L/min. The flow rate of ammonia gas to be introduced through the gas feed port in a corresponding time was calculated to be 4.48 L/min. The stator-rotor clearance of the reactor was 0.1 mm, and the rotation speed of the rotor was 5000 rpm. The slurry obtained from the reaction was crystallized at 100° C. in a crystallization reactor for 3 h, and the product was obtained after filtration, washing, and drying. The average particle size of the product was 50 nm, with a particle size distribution of 30-70 nm.

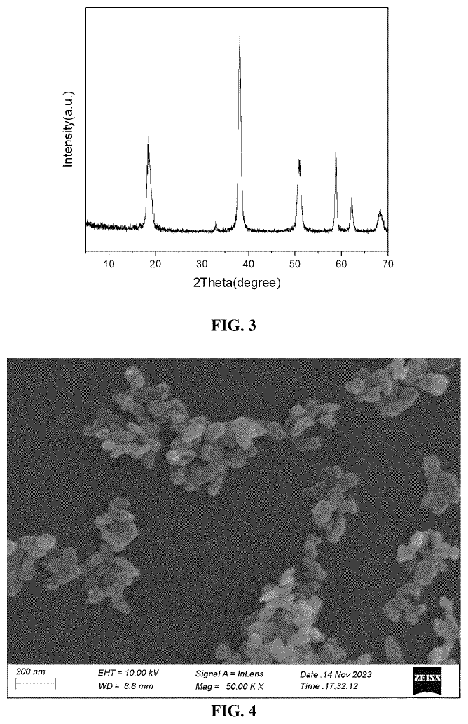

The crystal structure of the product was characterized using XRD6000 X-ray powder diffractometer from Shimadzu. FIG. 3 shows a XRD spectra, from which it can be seen that the characteristic diffraction peaks of Mg(OH)₂ appear approximately at 2θ=4.8°, 38.0°, 50.8°, and 58.7°, with sharp peaks and a low and flat baseline, indicating that the product has a complete crystal structure.

The particle size and the morphology were observed using the Hitachi H-800 transmission electron microscope. FIG. 4 is a scanning electron microscope image, from which it can be seen that the particle size of the product is from 30 to 60 nm.

### Example 2

The rotating liquid film reactor with gas-liquid multi-fluid concurrent in FIG. 1 comprises a closed casing as a stator, the stator has an upper end that is closed; a rotatable conical rotor is provided in the stator, a motor is connected with the rotor from below; a reactor body is composed of the stator and the rotor that is rotatable freely and connected to the motor; the stator-rotor clearance is 0.3 mm. The inner wall of the stator and the surface of the rotor stated are engraved with threads in a direction at 40°, the rotor height is 10 cm, and the inclination angle of the rotor is 75°. An anti overflow device is further provided by providing a circular hole-type adjusting bolt on a horizontal plane above the stator, with a height of 12 cm, which is connected with the rotor inside. A plurality of liquid feed port is symmetrically arranged on both left and right sides of the stator. Six liquid feed ports are constructed to be uniformly distributed. The liquid feed ports are located between the stator and the rotor, and the lower end of the feed ports is lower than the upper edge of the rotor. The reaction liquid is injected in a direction tangential to a direction of rotation of the rotor. The gas feed ports are located in the upper middle part of the rotor, and the gas flows out through a gas disperser with a bore diameter of 2 mm. The inclination angle of the rotor is an angle between an inclined edge and a bottom edge of the rotor in the vertical direction.

Specific operations in the use of the rotating liquid film reactor with gas-liquid multi-fluid concurrent in the preparation of aluminum hydroxide are described below.

AlCl₃ and NH₃ were injected at a molar ratio NH₃/Al³⁺=4:1 in the same feed time, where [Al³⁺]=1.0 mol/L, the liquids were injected through six liquid feed ports at 0.1 L/min. The flow rate of ammonia gas to be introduced through the gas feed port in a corresponding time was calculated to be 8.96 L/min. The rotation speed of the rotor was 4000 rpm. The slurry obtained from the reaction was crystallized at 60° C. in a crystallization reactor for 6 h, and the Al(OH)₃ product was obtained after filtration, washing, and drying. The average particle size of the product was 90 nm, with a particle size distribution of 60-160 nm.

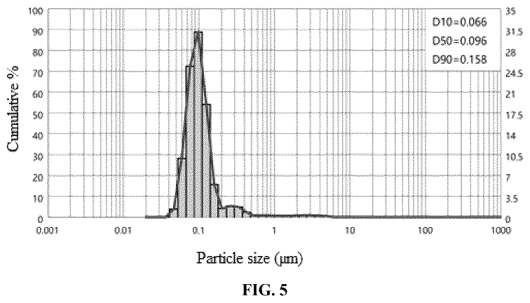

The particle size of the sample was measured by Malvern mastersizer 2000 laser particle size analyzer. FIG. 5 illustrates the laser particle size distribution, from which it can be seen that the average particle size of the product is 96 nm and d₉₀=152 nm.

### Example 3

The rotating liquid film reactor with gas-liquid multi-fluid concurrent in FIG. 1 comprises a closed casing as a stator, the stator has an upper end that is closed; a rotatable conical rotor is provided in the stator, a motor is connected with the rotor from below; a reactor body is composed of the stator and the rotor that is rotatable freely and connected to the motor; the stator-rotor clearance is 0.2 mm. The inner wall of the stator and the surface of the rotor stated are engraved with threads in a direction at 60°, the rotor height is 12 cm, and the inclination angle of the rotor is 70°. An anti overflow device is further provided by providing a circular hole-type adjusting bolt on a horizontal plane above the stator, with a height of 15 cm, which is connected with the rotor inside. A plurality of liquid feed port is symmetrically arranged on both left and right sides of the stator. Eight liquid feed ports are constructed to be uniformly distributed. The liquid feed ports are located between the stator and the rotor, and the lower end of the feed ports is lower than the upper edge of the rotor. The reaction liquid is injected in a direction tangential to a direction of rotation of the rotor. The gas feed ports are located in the upper middle part of the rotor, and the gas flows out through a gas disperser with a bore diameter of 3 mm. The inclination angle of the rotor is an angle between an inclined edge and a bottom edge of the rotor in the vertical direction.

Specific operations in the use of the rotating liquid film reactor with gas-liquid multi-fluid concurrent in the preparation of lanthanum hydroxide are described below.

LaCl₃ and an ammonia gas were injected at a molar ratio NH₃/La³⁺=5:1 in the same feed time, where [La³⁺]=1.0 mol/L, the liquids were injected through eight liquid feed ports at 0.1 L/min. The flow rate of ammonia gas to be introduced through the gas feed port in a corresponding time was calculated to be 11.2 L/min. The rotation speed of the rotor was 3000 rpm. The slurry obtained from the reaction was crystallized at 120° C. in a crystallization reactor for 1 h, and the La (OH) 3 product was obtained after filtration, washing, and drying. The average particle size of the product was 100 nm, with a particle size distribution of 80-140 nm.

What is claimed is:

1. A rotating liquid film reactor with gas-liquid multi-fluid concurrent, wherein the reactor comprises a closed casing as a stator, the stator has an upper end that is closed; a rotatable conical rotor is provided in the stator, a motor is connected with the rotor from below; a reactor body is composed of the stator and the rotor that is rotatable freely and connected to the motor; a plurality of liquid feed ports are symmetrically arranged on both left and right sides of the stator, a liquid is fed in a direction tangential to a direction of rotation of the rotor, the liquid feed ports are located between the stator and the rotor, and a lower end of the liquid feed ports is lower than an upper edge of the rotor and located in an upper half portion of the rotor; a gas feed port is constructed at a central position of the stator, gas is introduced into the upper half portion of the rotor; a gas disperser is provided in the rotor; a reaction liquid is injected through the liquid feed port, either from the same side or opposite sides, to a level of ¼ to ½ of a height of the inlet in the rotor; a gas is injected through the gas feed port and uniformly outflows through the gas disperser, a height of a gas outlet is lower than that of a liquid outlet; a discharge port is provided at a lower end of the stator.

2. The rotating liquid film reactor with gas-liquid multi-fluid concurrent according to claim 1, wherein the feed port is provided in four arranged in a cross pattern, in six uniformly distributed at an angle of 60°, or in eight uniformly distributed at an angle of 45°.

3. The rotating liquid film reactor with gas-liquid multi-fluid concurrent according to claim 1, wherein an anti overflow device is further provided by providing two circular hole-type adjusting bolts on opposite sides horizontally above the stator, with a height of 10-20 cm, which are connected with the rotor inside.

4. The rotating liquid film reactor with gas-liquid multi-fluid concurrent according to claim 1, wherein an inner wall of the stator and a surface of the rotor are engraved with threads in a direction at 10° to 170°.

5. The rotating liquid film reactor with gas-liquid multi-fluid concurrent according to claim 1, wherein a stator-rotor clearance is 0.1-0.5 mm, and a rotor height is 5-25 cm.

6. The rotating liquid film reactor with gas-liquid multi-fluid concurrent according to claim 1, wherein an inclination angle of the rotor which is an angle between an inclined edge and a bottom edge of the rotor in the vertical direction is in the range of 36° to 86°.

7. The rotating liquid film reactor with gas-liquid multi-fluid concurrent according to claim 1, wherein a bore diameter of the disperser is 1-3 mm.

8. The rotating liquid film reactor with gas-liquid multi-fluid concurrent according to claim 1, wherein a rotor speed is in a range of 50 to 8000 rpm, and a fluid mixing flow rate in the reactor is 7 to 150 m/s.

9. Use of the rotating liquid film reactor with gas-liquid multi-fluid concurrent according to claim 1 in preparation of metal hydroxides.

10. The use according to claim 9, wherein the metal hydroxides are magnesium hydroxide, aluminum hydroxide, or lanthanum hydroxide, comprising introducing an ammonia gas through a gas feed port, introducing a magnesium salt solution, an aluminum salt solution, or a lanthanide salt solution through a liquid feed port.
